(19) United States
(12) Patent Application Publication
(10) Pub. No.: US 2021/0368745 A1
(43) Pub. Date: Dec. 2, 2021

(54) METHOD AND APPARATUS FOR FISH FARMS

(71) Applicant: GIS Gas Infusion Systems Inc., Saint Andrews (CA)

(72) Inventors: Mike Beattie, Saint Andrews (CA); David Glassford, Saint Andrews (CA)

(73) Assignee: GIS Gas Infusion Systems Inc., Saint Andrews, NB (CA)

(21) Appl. No.: 16/956,822

(22) PCT Filed: Dec. 21, 2018
(86) PCT No.: PCT/CA2018/051663

§ 371 Date: Jun. 22, 2020

Related U.S. Application Data
(60) Provisional application No. 62/608,813, filed on Dec. 21, 2017.

(51) Int. Cl. A01K 61/13; A01K 63/04

(52) U.S. Cl. CPC A01K 61/13; A01K 63/042

(57) ABSTRACT

A process and apparatus is described for enhancing the efficacy and longevity of vaccines given to fish.

### FIELD

The invention relates generally to aquaculture and tropical fish farms.

### BACKGROUND

In the field of aquaculture, it is often desirable/necessary to vaccinate fish.

### SUMMARY

Forming one aspect of the invention is a method for use with a plurality of vaccinated fish in water, the method comprising the step of maintaining the levels of dissolved oxygen in the water at or above about 150% of ambient.

According to another aspect of the invention, CO₂ and ammonia produced by the fish can be removed from the water.

Forming another aspect of the invention is apparatus for use with a plurality of fish in water. This apparatus comprises means for maintaining the levels of dissolved oxygen in the water at or above about 150% of ambient.

According to another aspect, the apparatus can further comprise means for removing CO₂ and ammonia produced by the fish from the water.

### BRIEF DESCRIPTION OF THE FIGURES

FIG. 1 is a histogram showing experimental results

### DETAILED DESCRIPTION OF AN EXEMPLARY EMBODIMENT OF THE METHOD AND AN EXEMPLARY EMBODIMENT OF THE APPARATUS

The exemplary method is for use with a plurality of vaccinated fish in water and comprises the step of maintaining levels of dissolved oxygen in the water at or above about 150% of ambient and the removal of CO₂ and ammonia from the water.

The exemplary apparatus comprises a saturator of the type described in U.S. Pat. No. 7,537,200 to add oxygen and a lift pump to strip CO₂ and convert ammonia to nitrate. The system to remove CO₂ and ammonia is run by one or more lift pumps. The lift pump relies upon using injected air to reduce the water density within the pump and thereby causes the water to rise, which enables more water to enter the pump. As the water rises through the pump, dissolved CO₂ from fish respiration is exchanged with the injected air based on Henry's Law. To remediate ammonia, the lift pumps contains bacterial media which work to convert ammonia either directly, or in stages, to nitrate.

### Experimental

A plurality of Atlantic salmon were split into three groups. One group of fish was provided an ambient environment (+/−5% DO). Another group was held at 150% DO (+/−5% DO) and the third was held at 200% DO (+/−5% DO). Fish entered the tanks at first feeding and were maintained under these conditions for a period of 15 months. Water temperature, DO %, TGP (total gas pressure), CO₂ and salinity were measured and recorded 4 times per day. Fish were fed by automatic feeders and topped up after the final feeding of the day with manual feeding to ensure that fish were satiated. All the tanks contained probes for DO % looping back to an automated PLC controlled unit to ensure a variance of no more than 5% DO.

When the fry reached 10 grams, the fish were anaesthetized with Aqualife MS-222 (to immobilize for gentler handling) and administered a 0.05 mL injection of vaccine intraperitoneally one fin length ahead of the pelvic fins along the midline. The vaccine was Forte V II Elanco fish vaccine, (US Vet. Permit No. 303A) PCN: 4A45.20. The vaccine was allowed to warm to room temperature (15-20° C., 59-68° F.) to facilitate injection, as recommended by the manufacturer. Fish were withheld from food 48 hours prior to vaccination according to industry standards.

624 degree days (12 C water temperature×52 days) post vaccination, fish were randomly selected from each tank for blood collection. Blood was collected via the caudal vein using 22 gage, 5 ml vacutainers, each individually/uniquely marked (ie. A1, A2, A3, etc.). Blood sample tubes were set in trays for 1-2 minutes to allow for sufficient clotting. The tubes were then centrifuged at 10,000 rpm for 8 minutes. Blood serum was then drawn/decanted from the tubes and transferred to new 2 ml tubes, with duplicate markings. The 2 ml tubes were immediately placed into a 4 C fridge for storage.

Markings on the tubes were changed to reflect a master sheet coded list derived from randomly generated numbers. The latter is carried out in order to remove the potential for bias (laboratory was blinded) and thereafter analysis was carried out on the blood serum for IgM titre levels using conventional ELIZA (enzyme linked immunosorbent assay) followed by optical density measurements.

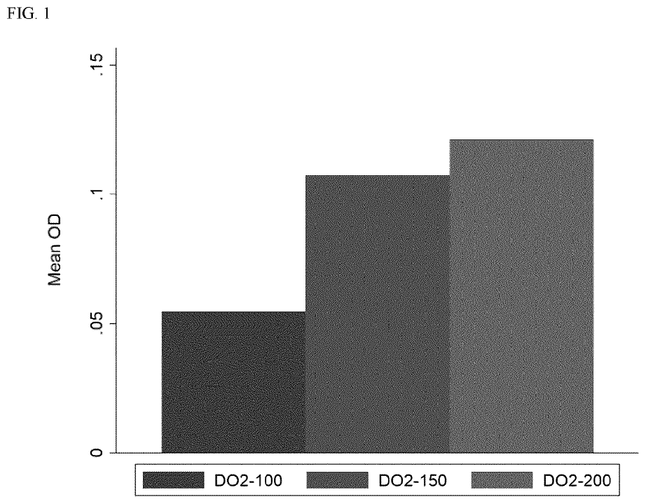

FIG. 1 illustrates the results in histogram bar format. The x-axis indicates the oxygenated groups (DO2-100 is the data for the 100% DO group, DO2-150 is the data for the 150% DO group and DO2-200 is the data for the 200% DO group). The y-axis indicates the mean optical density levels. Each oxygenated group represents the combined mean results from 9 fish. The graph clearly indicates that the oxygenated group 150% DO had 2 times the IgM titre levels when compared to the ambient, 100% DO group. The oxygenated 200% DO group had more than twice the IgM titre levels compared to the ambient, 100% DO group.

The oxygenated 200% DO group had higher IgM titre levels than the 150% DO group, however the difference was not statistically significant. Oxygenation at 200% DO does not appear to be essential; oxygenation to about 150% DO appears to provide relatively good results at relatively good cost.

The level of IgM titres in fish are directly related to both efficacy and longevity of fish vaccines. Accordingly, the study clearly demonstrates that fish exposed to high oxygen saturated water, pre and post vaccination, demonstrated higher levels of IgM titres when compared to fish exposed to ambient oxygen saturated water.

Thus exposure to relatively high levels of oxygen saturated water enhances the efficacy and longevity of fish vaccines.

Whereas a single embodiment of the method and apparatus are described, it will be evident that variations are possible.

Without limitation, it will be understood that DO levels below 150% and above 200% may have utility.

Accordingly, the invention should be understood to be limited only by the accompanying claims, purposively construed.

1. A method for use with a plurality of vaccinated fish in water, the method comprising the step of:
maintaining the levels of dissolved oxygen in the water at or above about 150% of ambient.

2. A method according to claim 1, wherein CO₂ and ammonia produced by the fish are removed from the water.

3. Apparatus for use with a plurality of fish in water comprises:
means for maintaining the levels of dissolved oxygen in the water at or above about 150% of ambient.

4. Apparatus according to claim 3, further comprising:
means for removing CO₂ and ammonia produced by the fish from the water.
